(19) United States
(12) Patent Application Publication
(10) Pub. No.: US 2001/0019551 A1
(43) Pub. Date: Sep. 6, 2001

(54) TSSI monitoring device as well as appertaining method

(76) Inventors: Karsten Laubner, Muenchen (DE); Marcel-Abraham Troost, Muenchen (DE)

Correspondence Address: SCHIFF HARDIN & WAITE, Patent Department, 6600 Sears Tower, 233 South Wacker Drive, Chicago, IL, 60606, US

(21) Appl. No.: 09/737,262

(22) Filed: Dec. 13, 2000

(30) Foreign Application Priority Data
Dec. 17, 1999 (DE) 19961139.4

(51) Int. Cl. H04L 12/50; H04Q 11/00

(52) U.S. Cl. 370/369; 370/375

(57) ABSTRACT

The invention is directed to a TSSI monitoring device as well as to an appertaining method with a TSSI insertion device (1) for inserting a TSSI monitoring value (D (t₀)) into a predetermined data channel (tssi) of successive time frames to be switched, and with a difference forming mechanism (2) for forming a difference (Δ=(D (t₀)−D(t₀₊ₖ)) of data contents of the switched, predetermined data channel for immediate successive time frames. In this way, a TSSI infringement can be identified in an especially simple and cost-beneficial way in a switching network.

### BACKGROUND OF THE INVENTION

1. Field of the Invention

The present invention is directed to a TSSI monitoring device as well as to an appertaining method and, in particular, to a TSSI monitoring device for monitoring a correct time slot sequence in a switching network of a telecommunication switching system.

2. Description of the Related Art

It is necessary, particularly in digital telecommunication switching systems, to monitor a correct time slot sequence in an appertaining time slot system in order to assure a correct sequence of data channels to be switched at any time.

U.S. Pat. No. 4,592,044, for example, discloses a TSSI monitoring device and an appertaining method, in which a predetermined control bit for each data word or each channel in a time frame is switched from its normal control bit function into a PRS bit that contains a pseudo-random data value. This bit is employed for monitoring a correct time slot sequence in which it is compared to a pseudo-random reference value.

Furthermore, International patent document WO 98/41054 discloses another TSI monitoring device in which a correct time slot sequence is essentially achieved by employing redundant speech memories in a switching network. In this way, two complete time frames can be deposited in a speech memory, resulting in the correct sequence of time slots or of the appertaining data channels to be switched being determined.

What is disadvantageous about these traditional TSSI monitoring devices and appertaining methods, however, is that the hardware outlay and/or the control outlay is high, as a resulting in increased costs rise for the telecommunication system and the monitoring.

### SUMMARY OF THE INVENTION

The invention is therefore based on the object of creating a TSSI monitoring device as well as an appertaining method that realizes a monitoring of a correct time slot sequence in a switching network of a telecommunication switching system in a simple and cost-beneficial way.

This object is achieved by a TSSI monitoring device for monitoring a correct time slot sequence in a time/space switching network for a time or space allocation of data channels to be switched, comprising a TSSI insertion mechanism for inserting a TSSI monitoring value into a predetermined data channel of successive frames to be switched, wherein the TSSI monitoring value for each frame is incremented or decremented by a predetermined value; and a difference forming mechanism for forming a difference of data contents of the predetermined data channel for immediately successive frames to be switched by the time/space switching network, wherein the difference is equal to the predetermined value for a correct time slot sequence.

This object is also achieved by a method for monitoring a correct time slot sequence in a time/space switching network for a time or space allocation of data channels to be switched, comprising the steps of inserting a TSSI monitoring value into a predetermined data channel of successive frames to be switched, wherein the TSSI monitoring value for each frame is incremented or decremented by a predetermined value; time or space allocating the data channels to be switched in the time/space switching network; forming a difference of data contents of the data channel to be switched by the time/space switching network for immediately successive frames; and outputting an error value when the difference is not equal to the predetermined value.

A monitoring device for monitoring a correct time slot sequence in a switching network is obtained in a simple and cost-beneficial way, particularly by employing a TSSI insertion device for inserting TSSI monitoring values into a predetermined data channel of successive time frames to be switched, in which the TSSI monitoring value is raised or lowered in some amount for each frame, and by employing a difference forming device for forming a difference of data contents of the switched, predetermined data channel for immediately successive time frames.

Preferably, the data channel to be switched represents a test channel of the frame in the time-division multiplex system, resulting in an on-line monitoring for the correct time slot sequence being realized without influencing payload channels to be switched.

When the predetermined value is generated by a counter respectively incremented by the value 1, then a further simplification derives for the difference forming mechanism since a difference that is formed given a correct time slot sequence always exhibits the value 1.

A delay device, a subtraction device and a comparator device that are arranged at the data output of a switching network are preferably employed for realizing the difference forming mechanism. Furthermore, when the delay device is realized by a speech memory present in the switching network, then a further simplification of the TSSI monitoring device derives in which, particularly, traditional switching components can be employed.

Further advantageous embodiments of the device include providing an error counter for counting TSSI errors for a lack of agreement between the formed difference and the predetermined value. The predetermined value may be equal to one and be derived from a counter. The difference forming mechanism may further comprise a delay for delaying a predetermined data channel to be switched by one frame; a subtractor for determining a subtraction result from a data content of a delayed data channel and a data content of an undelayed data channel; and a comparator unit for comparing the subtraction result with the predetermined value. The delay may comprise at least one speech memory of the time/space switching network, and the TSSI insertion mechanism may comprise a plurality of TSSI insertion units that are respectively allocated to an input switching network line. The difference forming mechanism may comprise a plurality of difference forming units that are respectively allocated to two output switching network lines, and the error counter may comprise a plurality of error counting units that are respectively allocated to a difference forming unit. The TSSI insertion mechanism may be

### DESCRIPTION OF THE PREFERRED EMBODIMENTS

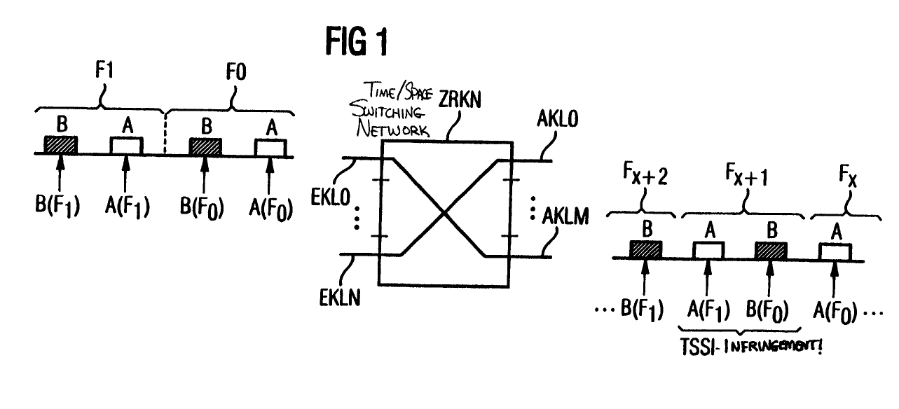

FIG. 1 shows a simplified illustration for explaining a faulty time slot sequence or TSSI infringement (of the time slot sequence integrity) that can be recognized by the inventive TSSI monitoring device.

A plurality of data channels are usually re-ordered or re-allocated in time and space in a time/space switching network ZRKN, resulting in an actual switching in a telecommunication switching system. Usually, the time/space switching network ZRKN has N input switching network lines EKL0 through EKLN and M output switching network lines AKL0 through AKLM, resulting in an N/M switching network. Each of the input switching network lines ELK0 through EKLN as well as the output switching network lines AKL0 through AKLM usually has a time-division multiplex structure, in which a plurality of data channels are transmitted in successive frames. Each data channel is allocated to a time slot of the time-division multiplex system and represents a fixed connection channel between two subscribers (not shown).

According to FIG. 1, the data contents, for example, A(F0), B(F0), A(F1) and B(F1) in a multi-channel connection (i.e., in the channels A and B belonging to a connection) are supplied to the time/space switching network ZRKN in succession in the successive time frames F0, F1, etc. via the input switching network line EKL0, and the time/space switching network ZRKN reallocates these in time and space in conformity with a control device (not shown). For such a time and space allocation, a temporal transposition of the data contents can then occur, as a result of which a faulty time slot sequence can derive at the output switching network lines AKL0 through AKLM.

Stated more precisely the data contents, for example, B(F0) and A(F1) transmitted in the same frame in a common connection on the output switching network line AKLM have Fx+1 different indices. In order to avoid such TSSI infringements, a monitoring of the correct time slot sequence (TSSI, time slot sequence integrity) is therefore necessary.

Since faulty time slot sequences can also occur statistically distributed and/or sporadically, quantitative monitoring possibilities are required over and above this for the analysis of such errors.

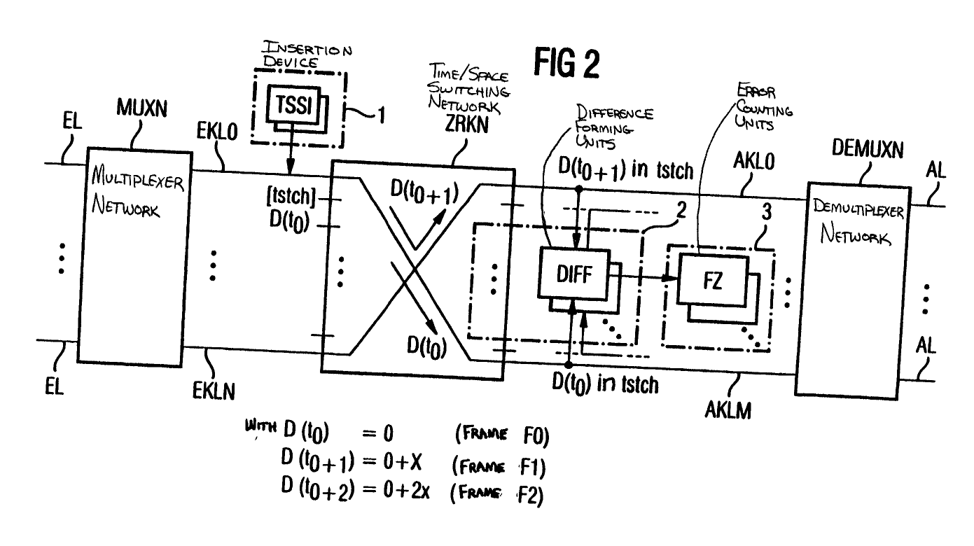

FIG. 2 shows a simplified block illustration of a switching network having a TSSI monitoring device according to the present invention.

The switching network comprises a switching network of the type D as employed in the Siemens EWSD switching system. Input lines EL, which are usually supplied by line/trunk groups, are first compressed in a multiplexer network MUXN and are supplied to a time/space switching network ZRKN. The multiplexer network MUXN compresses, for example, 16 input lines EL having a data volume of respectively 128 payload channels, where each data channel usually comprises 64 kbit/s. Additionally, these 16 times 128 payload channels have an additional 2 times 128 test channels attached to them, resulting in a time-division multiplex system having a frame structure of 2304 data channels. Furthermore, each data channel can be expanded by additional test bits, resulting in further channel-individual testing possibilities.

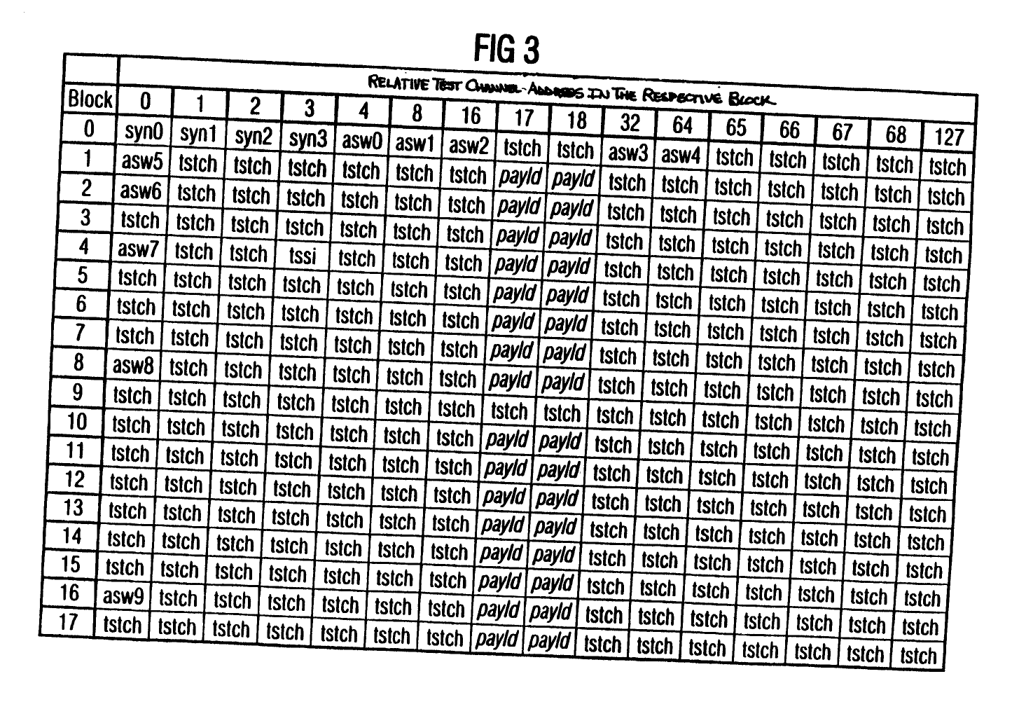

FIG. 3 shows a simplified illustration of the frame structure that is preferably transmitted on the input switching network lines EKL and output switching network lines AKL according to FIG. 2. According to FIG. 3, data streams of approximately 184 Mbit/s are switched, where the data channels comprise test channels tstch, syn and asw (a total of 2 times 128 data channels) as well as of payload channels payId (a total of 16 times 128 data channels). FIG. 3 only shows a portion of the overall frame structure (a total of 2304 data channels), where, in particular, the relative channel address 5 through 7, 9 through 15, 19 through 31, 33 through 63 and 69 through 126 are not shown for the sake of simplicity. The further payload channels payId are merely transmitted in the switching network via these further, relative channel addresses of the synchronous time-division multiplex frame.

According to FIG. 3, the synchronous time-division multiplex frame accordingly, contains 16 times 128 payload channels as transmitted, for example, by 16 line/trunk groups and generated by the multiplexer network MUXN. What is particularly critical for the present invention is the employment of 2 times 128=256 test channels tstch, syn as well as asw that are essentially deposited in the relative channel addresses 0 through 4, 8, 16 through 18, 32, 64 through 68 and 127.

The test channels syn essentially serve for a synchronization monitoring and the test channels asw serve for a subsequent monitoring (not described in greater detail) of address lines for speech memories in the switching network—such a frame structure also has a plurality of three test channels tstch.

The present invention is then essentially directed to the employment of one of these three, available test channels tstch as referenced, for example, with tssi in the relative channel address 3 of the block 4, resulting in an online testing capability. However, the inventive TSSI monitoring can also fundamentally occur via an available payload channel payId, in which an online testing capability is limited.

Returning again to FIG. 2, the functioning of the inventive TSSI monitoring device is described below. According to FIG. 2, a TSSI insertion device 1 is located in the switching network for inserting a TSSI monitoring value D(t₀), D(t₀₊₁), D(t₀₊₂), through D(t₀₊ₖ), where k represents a whole natural number, for example, in the predetermined data channel tssi of successive time frames F0, F1, F2, through Fk to be switched. The TSSI monitoring value D(t₀) through D(t₀₊ₖ) is incremented or decremented by a value x that is constant in value for each time frame F0 through Fk. Accordingly, the data content of the predetermined data channels tssi to be switched has a direct correlation to its respective time frame.

Subsequently, the predetermined data channel tssi to be switched is reordered or switched in time and space such that, for example, the data content D(t₀) for the time frame F0 is undelayed at the output switching network line AKLM, whereas the data content D(t₀₊₁) of the following time frame F1 is rerouted undelayed onto the output switching network line AKL0. Accordingly, the data contents of two time frames that immediately follow one another in time in the predetermined data channel tssi are adjacent in the spatially separated output switching network lines AKL0 and AKLM.

A difference forming mechanism 2 then forms a difference of the data contents of the predetermined data channel tssi switched by the time/space switching network ZRKN for the immediately succeeding time frames, where a difference D(t₀)−D(t₀₊₁)—given a correct time slot sequence—agrees in amount with the predetermined value x inserted in the tssi insertion device 1. A monitoring device for monitoring a correct time slot sequence in a switching network is thus obtained in a simple and cost-beneficial way.

For statistical interpretation of, for example, sporadically occurring errors in the time slot sequence, an error counting mechanism 3 can additionally be provided for counting the tssi errors generated by the difference forming mechanism 2.

According to FIG. 2, the TSSI insertion device 1 can be composed of a plurality of TSSI insertion units TSSI that are respectively allocated to an input switching network line EKL0 through EKLN. Furthermore, the difference forming mechanism 2 can be composed of a plurality of difference forming units DIFF that are respectively allocated to two output switching network lines AKL0 through AKLM. In the same way, the error counting mechanism 3 can be composed of a plurality of error counting units FZ that are respectively allocated to a difference forming unit DIFF. For such a graduated structure of the TSSI monitoring mechanism, one obtains a complete TSSI monitoring of the time/space switching network ZRKN in which a faulty time slot sequence or TSSI infringement (time slot sequence integrity) can be very exactly acquired and localized. An error analysis or elimination can be further-improved in the time/space switching network ZRKN.

The data channels switched in this way are supplied via the output switching network lines AKL0 through AKLM to a demultiplexing network DEMUXN at the output side in which a division of the compressed data channels in turn ensues into a plurality of output lines, and, preferably, the further test channels and/or test bits (not shown) are interpreted.

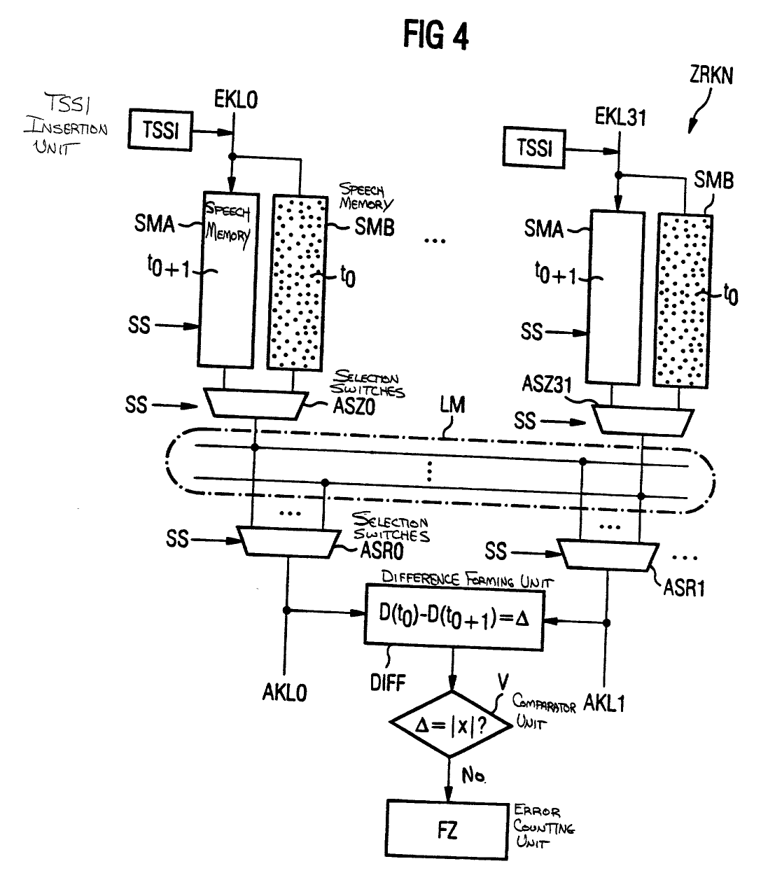

FIG. 4 shows a simplified block illustration of a time/space switching element for realizing the time/space switching network ZRKN. Such an element or module has—according to FIG. 4—32 input switching network lines EKL0 through EKL31 with a corresponding plurality of memory devices or speech memories SMA and SMB. The speech memories SMA and SMB are connected in parallel and are selectively read out via appertaining selection switches ASZ0 through ASZ31. A line matrix LM with appertaining selection switches ASR0 through ASRM serves essentially for a spatial allocation of the data channels temporally allocated in the speech memories SMA and SMB, where the selection switches ASR0 through ASRM are allocated to a respective output switching network line AKL0 through AKLM.

The TSSI insertion units TSSI of the TSSI insertion means are located— according to FIG. 4—in an input area of the time/space switching network ZRKN. Preferably, these TSSI insertion units of the TSSI insertion mechanism 1, however, are realized in a preceding equalizer (not shown) that essentially produces a synchronous data stream from a plurality of asynchronous data frames.

For realizing the TSSI monitoring, the TSSI insertion unit TSSI first inserts a TSSI monitoring value D(t₀) through D(t₀₊ₖ) into successive frames in the predetermined data channels tssi to be switched, this preferably representing a test channel tstch, in which the TSSI insertion unit is preferably realized by a counter and, accordingly, inserts a data content incremented by the value 1 for each successive time frame.

For realizing a delay, a complete time frame F0 with the appertaining data channels is deposited in the speech memory SMB at time t₀, and—after the speech memory SMB has been completely filled—the speech memory SMA is filled in the same way with the data channels for the time t(₀₊₁) of the time frame F1. The payload channels are temporally allocated in the speech memories in a standard way by a controller (not shown) via control signals SS. The data contents of the predetermined data channels tssi to be switched are, in particular, separately switched or allocated such that the data content D(t₀) is supplied to the output switching network line AKL0 delayed by one frame via the selection switch ASZ0, the line matrix LM and the selection switch ASR0. The data content D(t₀₊₁) supplied in the speech memory SMA is supplied undelayed via the line matrix LM and the selection switch ASR1 to the output switching network line AKL1. In this way, the data contents D(t₀) and D(t₀₊₁) of two immediately successive time frames of the predetermined data channels tssi are located on the different output switching network lines AKL0 and AKL1 at the same point in time and can be subtracted in a simple way with the difference forming unit DIFF.

The subtraction result formed in the difference forming unit DIFF is subsequently supplied to a comparator unit V that essentially compares the difference to the predetermined value x in terms of amount and indicates a TSSI infringement when the two values deviate from one another. Particularly given employment of a counter that simply increments the data content for the predetermined data channel tssi in the TSSI insertion unit TSSI by the value 1 (x= 1), an error-free time slot sequence is obtained given a difference value of 1 for the difference formed in the difference forming unit DIFF. On the other hand, a TSSI infringement is indicated given a faulty shift with the data contents in a second, third, fourth, etc. time frame and, for example, the error counting unit FZ is incremented.

A TSSI monitoring upon employment of the further speech memories SMA and SMB of the further input switching network lines 1 through 31 can ensue in the same way for the further output switching network lines AKL2 and AKL3 (not shown), where, for a plurality of such monitoring units, a respective element in the time/space switching network ZRKN causing a respective TSSI error can be quickly and simply localized.

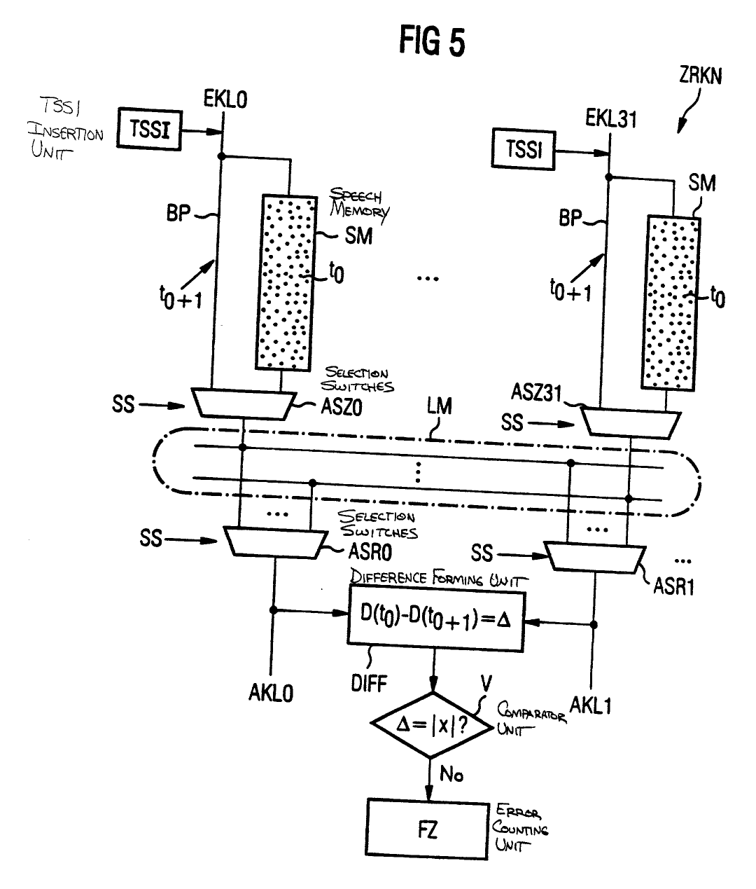

FIG. 5 shows a simplified block illustration of a time/space switching element or component for realizing a TSSI monitoring in a time/space switching network ZRKN according to a second exemplary embodiment. Identical reference characters reference the same or similar elements as in FIG. 4.

The critical difference of the circuit according to FIG. 5 compared to the circuit according to FIG. 4 is that the speech memories SMA are now replaced by a bypass line BP. As a result of this bypass line BP, one again obtains a time difference of data contents for respective time frames, as a result of which the data contents D(t₀) and D(t₀₊₁) of initially successive time frames can now again be isochronically allocated to the output switching network lines AKL0 and AKL1. A very simple interpretation possibility or, respectively, a monitoring of a TSSI infringement therefore again derives, which is completely identical to the TSSI monitoring described in FIG. 4.

The invention described above is based on a switching network in which a time frame having additional test channels for realizing the TSSI monitoring is employed. The invention, however, is not limited to this and, on the contrary, covers all further frame structures with or without test channels, in which, however, an online monitoring is only assured for the employment of test channels.

Furthermore, the invention was described on the basis of speech memories or bypass lines for realizing a data delay. However, it is not limited in this manner, and also covers all further possibilities of data delay of two successive time frames in a time/space switching network, as a result of which a direct comparison of respective data channel contents can be realized.

The above-described method and communication system are illustrative of the principles of the present invention. Numerous modifications and adaptations thereof will be readily apparent to those skilled in this art without departing from the spirit and scope of the present invention.

What is claimed is:

1. A TSSI monitoring device for monitoring a correct time slot sequence in a time/space switching network for a time or space allocation of data channels to be switched, comprising:
a TSSI insertion mechanism for inserting a TSSI monitoring value into a predetermined data channel of successive frames to be switched, wherein said TSSI monitoring value for each frame is incremented or decremented by a predetermined value; and
a difference forming mechanism for forming a difference of data contents of said predetermined data channel for immediately successive frames to be switched by said time/space switching network, wherein said difference is equal to said predetermined value for a correct time slot sequence.

2. The TSSI monitoring device according to claim 1, further comprising an error counter for counting TSSI errors for a lack of agreement between said formed difference and said predetermined value.

3. The TSSI monitoring device according to claim 1, wherein said predetermined value is equal to 1 and is derived from a counter.

4. The TSSI monitoring device according to claim 1, wherein said difference forming mechanism comprises:
a delay for delaying a predetermined data channel to be switched by one frame;
a subtractor for determining a subtraction result from a data content of a delayed data channel and a data content of an undelayed data channel; and
a comparator unit for comparing said subtraction result with said predetermined value.

5. The TSSI monitoring device according to claim 4, wherein said delay comprises at least one speech memory of said time/space switching network.

6. The TSSI monitoring device according to claim 1, wherein said TSSI insertion mechanism comprises a plurality of TSSI insertion units that are respectively allocated to an input switching network line.

7. The TSSI monitoring device according to claim 1, wherein said difference forming mechanism comprises a plurality of difference forming units that are respectively allocated to two output switching network lines.

8. The TSSI monitoring device according to claim 2, wherein said error counter comprises a plurality of error counting units that are respectively allocated to a difference forming unit.

9. The TSSI monitoring device according to claim 1, wherein said TSSI insertion mechanism is fashioned in an equalizer for producing a plurality of synchronous frames from non-synchronous frames.

10. The TSSI monitoring device according to claim 1, wherein said predetermined data channel to be switched represents a test channel.

11. A method for monitoring a correct time slot sequence in a time/space switching network for a time or space allocation of data channels to be switched, comprising the steps of:
inserting a TSSI monitoring value into a predetermined data channel of successive frames to be switched, wherein said TSSI monitoring value for each frame is incremented or decremented by a predetermined value;
time or space allocating said data channels to be switched in said time/space switching network;
forming a difference of data contents of said data channel to be switched by said time/space switching network for immediately successive frames; and
outputting an error value when said difference is not equal to said predetermined value.

12. The method according to claim 11, further comprising the step of:
incrementing an error counter dependent on said output error value.

13. The method according to claim 11, wherein said TSSI monitoring value is incremented by a predetermined value derived from a counter.

14. The method according to claim 11, wherein said step of forming a difference of data contents of said data channel comprises the steps of:
delaying said predetermined data channel to be switched by one frame;
determining a subtraction result from a data content of said delayed data channel and a data content of an undelayed data channel; and
comparing said identified subtraction result to said predetermined value.

15. The method according to patent claim 14, wherein said step of delaying said predetermined data channel is implemented in a speech memory of said time/space switching network.

16. The method according to claim 11, wherein said step of inserting a TSSI monitoring value is implemented for a plurality of input switching network lines.

17. The method according to claim 11, wherein said step of forming a difference of data contents of said data channel is implemented for a plurality of respectively two output switching network lines.

18. The method according to claim 11, wherein said step of inserting a TSSI monitoring value takes place in a test channel.

19. The method according to claim 13 wherein said predetermined value is one.
